(19) United States
(12) Patent Application Publication
(10) Pub. No.: US 2007/0278036 A1
(43) Pub. Date: Dec. 6, 2007

(54) Safety harness with suspension relief

(75) Inventors: Jim M. Barta, Trinity, AL (US); Jerry Dale Wydner, Trinity, AL (US); John D. Wydner, Danville, AL (US)

Correspondence Address: BRADLEY ARANT ROSE & WHITE LLP, 200 CLINTON AVE. WEST, SUITE 900, HUNTSVILLE, AL, 35801, US

(73) Assignee: The Hunter Safety System, Inc., Danville, AL (US)

(21) Appl. No.: 11/443,701

(22) Filed: May 31, 2006

(51) Int. Cl. A62B 35/00

(52) U.S. Cl. 182/3

(57) ABSTRACT

A safety harness system incorporating suspension relief for use by those engaging in activities at a height above the ground is provided. Such safety harness comprises a plurality of straps, for creating the basic skeletal structure of the harness, a tether, and a suspension relief extension. The safety harness system is constructed so as to allow the user to relieve weight or force on the harness and transfer such weight or force to the tether.

### BACKGROUND OF THE INVENTION

The present invention relates to the field of safety equipment. More particularly, the present invention relates to safety harnesses in general. Most particularly, the present invention relates to an improved safety harness providing suspension relief.

In cases where an individual is engaging in activity at an elevation, sitting or standing on a support, it is common to wear a harness on the upper body and to tether such harness to a fixed object. Should the support fail or the user slip, he or she will fall only a short distance and be suspended from the fixed object, thereby avoiding injury from a fall to the ground. One example of such a use of a safety harness includes a hunter elevated above the ground on a tree stand, tethered to the tree with a harness worn around the upper torso.

Safety harnesses combined with garments are known. These safety garments are designed to overcome the inconvenience of a harness that has many loops and straps, having a tendency to become twisted and entangled with one another. Adorning such a harness can be relatively time consuming and tedious. When the harness is inside, outside, or between inner and outer layers of a garment, however, the various loops and straps are more resistant to twisting and knotting and thus putting on the harness becomes as easy as putting on a jacket. One such garment is the Hunter Safety Systems combination safety harness and garment as disclosed in U.S. Pat. No. 6,637,547, which is fully incorporated herein by reference.

As depicted in U.S. Pat. No. 6,637,547, a typical harness may have one or more vertical back straps, one or more vertical shoulder straps, one or more horizontal chest straps, and leg straps. In order to close the basic skeletal structure of the harness about the user, the harness may use any number of well-known buckles or clipping mechanisms, including clip and clasp systems wherein a receptacle having a plurality of openings receives an inverted omega-shaped tab, or a receiver and slider or tongue plate system similar to those used for seat belts. The harness may not even have buckles or clipping mechanisms, but rather simply adjustable straps. The straps are normally adjustable using well-known adjustment means, and allows for the frictional retention of the strap at a user designated length through the use of the adjustment means. Additionally, the top of the vertical back strap has a loop, clip, or ring for attachment of a tether or lanyard suitable for connection to a fixed object. Further, the vertical back strap, preferably at the bottom, has a loop, clip, or ring for attachment of a tether for towing an object, for example a deer.

If a user does fall, it is possible for the user remain suspended for some length of time until they can climb back onto the fixed object or someone comes to their aid. In a typical vest, the weight of the user while suspended is likely transferred primarily to the leg straps. If leg straps are not used, the weight will likely be transferred to the horizontal chest straps which will apply pressure under the user's arm. If a user remains suspended for long periods of time, the straps and harness holding the user can restrict the circulation of blood, and depending on the configuration around the user's body, the user could potential pass out from lack of blood flow or otherwise suffer injury. Thus, a safety harness that can provide a user with suspension relief is needed.

### SUMMARY OF THE INVENTION

The present invention recognizes and addresses various of the foregoing need, and others, and can be used in combination with any number of harness configurations and buckle arrangements. Therefore, the present invention is generally directed to an improved safety harnesses featuring suspension relief.

In its most simple form, strap, loop or similar attachment is provided that is connected to or incorporated into the harness. For ease of reference, this feature will be referred to as a “suspension relief extension.” The suspension relief extension is configured to allow a user to transfer the user's weight from the area of the user's body that is bearing the primary load when supported solely by the tether attached to the fixed object (for example, a tree) to another area of the user's body, thereby allowing better blood and circulation providing the user suspension relief. When the user applies a force to the suspension relief extension, additional pressure may be transferred to other portions of the harness, for example, the shoulder straps or the vertical back strap(s).

In the preferred embodiment, at least one end of the suspension relief extension is configured to connect to the bottom of the vertical back strap and the other end configured to form one or more loops in the suspension relief extension that allows a user to “stand” in the loop(s). In this embodiment, the vertical back strap is also connected directly to the tether which is connected to the fixed object, and thus, virtually all of the force being applied to the suspension relief extension by the user's feet is transferred directly to the vertical back strap, and thus to the fixed tether. In this configuration, pressure on the user's leg straps and shoulder straps can be virtually eliminated.

For the purposes of this application the terms “connection” or “connected” are to be construed broadly. For example, when the tether is described as “connected’ to the back strap, it could be permanently fixed, it could be connected by a carabiner on the tether directly to a loop in the back strap material, or it could use D-rings with clips, or it could use buckles.

Having described at least one exemplary embodiment of the present invention, it is herein proclaimed that a primary object of the present invention is to provide an improved safety harness for users engaging in activities at a height that significantly enhances the safety of the user and provides suspension relief when a user is suspended.

Additional objects and advantages of the invention are set forth in, or will be apparent to those of ordinary skill in the art from, the detailed description as follows. Also, it should be further appreciated that modifications and variations to the specifically illustrated and discussed features and materials hereof may be practiced in various embodiments and uses of this invention without departing from the spirit and scope thereof, by virtue of present reference thereto. Such variations may include, but are not limited to, substitutions of the equivalent means, features, and materials for those shown or discussed, and the functional or positional reversal of various parts, features, or the like.

Still further, it is to be understood that different embodiments, as well as different presently preferred embodiments, of this invention, may include various combinations or configurations of presently disclosed features, elements, or their equivalents (including combinations of features or configurations thereof not expressly shown in the figures or stated in the detailed description).

These and other features, aspects and advantages of the present invention will become better understood with reference to the following descriptions and appended claims. The accompanying drawings, which are incorporated in and constitute a part of this specification, illustrate an embodiment of the invention and, together with the descriptions, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1A is a cross-sectional view of a garment showing the back and shoulder straps of a harness;

FIG. 1B is a cross-sectional view of the garment as depicted in FIG. 1a further showing the insertion of the chest straps;

FIG. 1C is a cross-sectional view of the garment as depicted in FIG. 1b further showing leg straps, and depicting clip and clasp buckles.

FIG. 2 is a cross-sectional view of the garment as depicted in FIG. 1c without the leg straps but further showing an embodiment of the suspension relief extension with one loop for a user's foot.

FIG. 3 is a cross-sectional view of the garment as depicted in FIG. 1c without the leg straps but further showing another embodiment of the suspension relief extension with two loops for the user's feet.

FIG. 4 is a depiction of a user wearing the harness garment and using the suspension relief extension.

Repeated use of reference characters throughout the present specification and appended drawings is intended to represent the same or analogous features or elements of the various exemplary embodiments of the present invention described and shown.

### Detailed Description of the Preferred Embodiments

Reference will now be made in detail to presently preferred embodiments of the invention, examples of which are fully represented in the accompanying drawings. Such examples are provided by way of an explanation of the invention, not limitation thereof. In fact, it will be apparent to those skilled in the art that various modifications and variations can be made in the present invention, without departing from the spirit and scope thereof. For instance, features illustrated or described as part of one embodiment can be used on another embodiment to yield a still further embodiment. Still further, variations in selection of materials and/or characteristics may be practiced, to satisfy particular desired user criteria. Thus, it is intended that the present invention cover such modifications and variations as come within the scope of the present features and their equivalents.

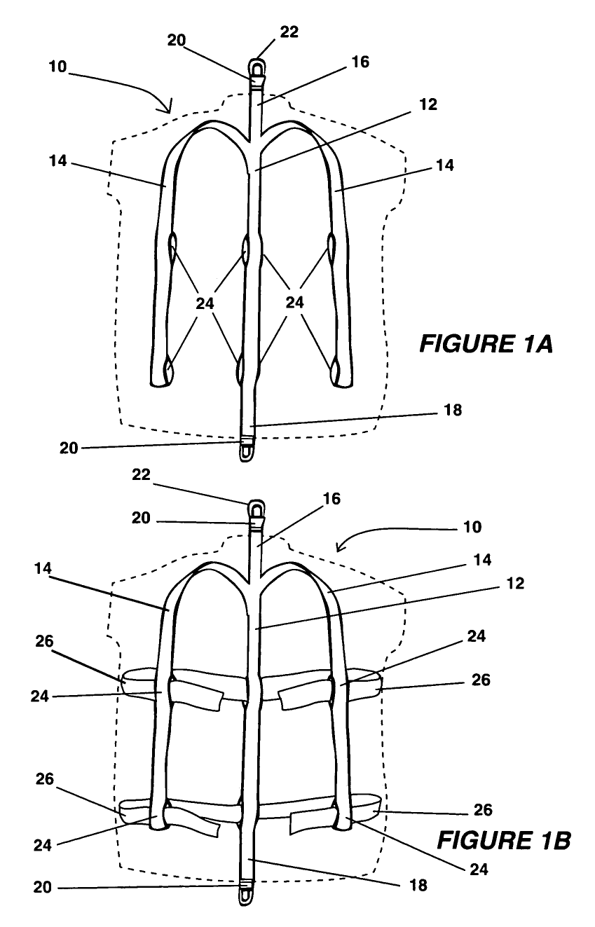

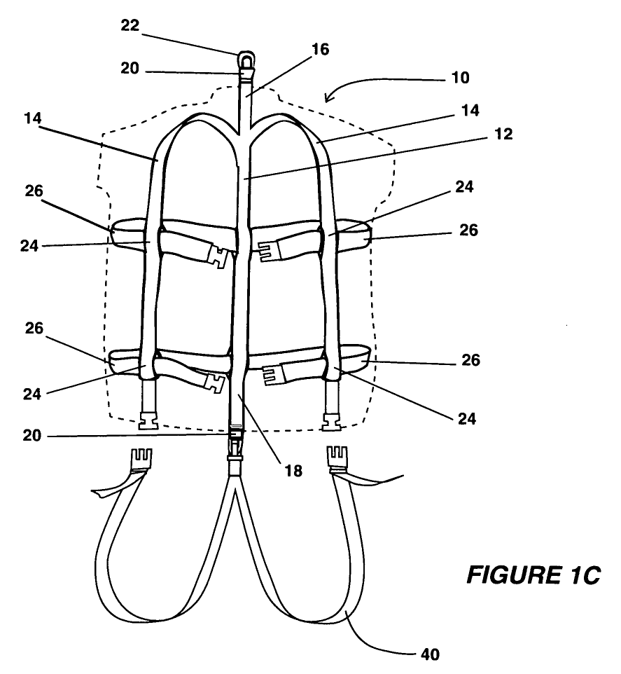

As disclosed above, the present invention is particularly concerned with a safety harness incorporating suspension relief. FIG. 1A shows an exemplary embodiment of the harness 10 of the present invention. The following description is with regard to the exemplary embodiment and is not to be construed as a limitation. The present exemplary embodiment is a garment comprising an outer shell having a safety harness affixed to the inside of such garment. Alternatively, such harness could be either affixed to the exterior of the garment or located between an inner and an outer layer of the shell, or not be incorporated into a garment at all.

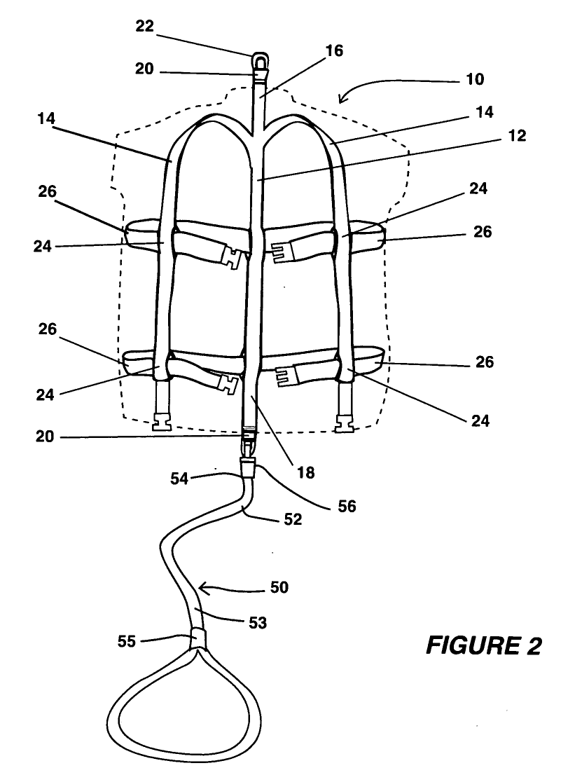

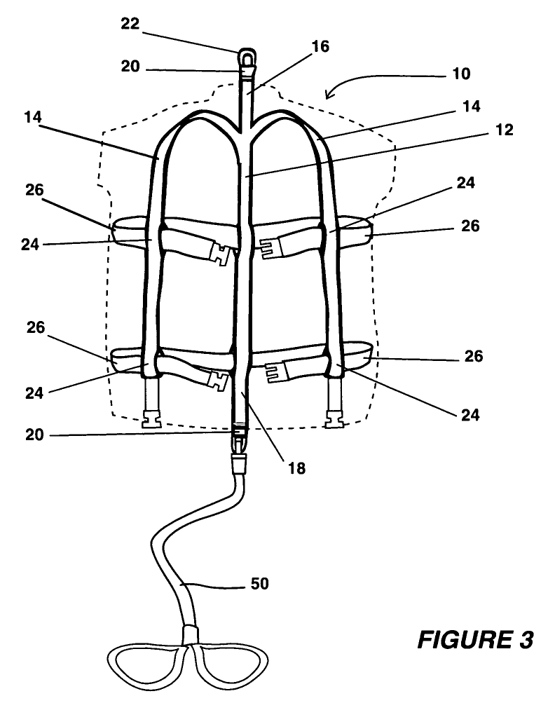

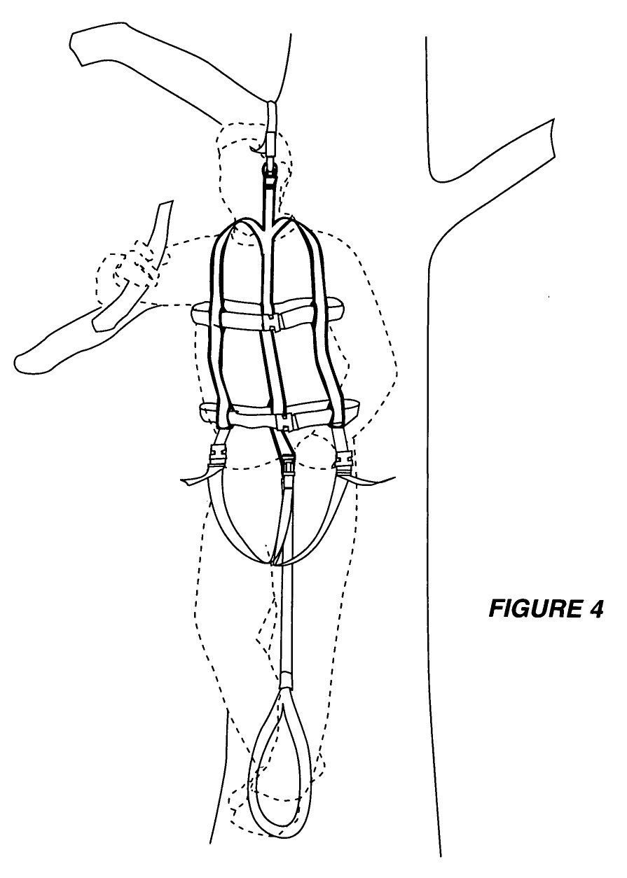

The harness 10 has at least one back strap 12, preferably vertical, and two shoulder straps 14, also preferably vertical. While the harness 10 may have more than one back strap 12, in the present exemplary embodiment only one is provided. Additionally, leg straps 40 (shown in FIG. 1C) may be provided. Back strap 12 has a top end 16 and a lower end 18. Preferably located at ends 16 and 18 are loops 20. The loop 20 at top end 16 may include a D-ring 22. The loop 20 or D-ring 22 are preferably used to connect the lanyard or tether, which is attached to a fixed object (shown in FIG. 4). Such fixed object, for example a tree in the case of a hunter, is used to secure the user and thus prevent a fall from their elevated position to the ground. Loop 20 at the lower end 18 of back strap 12 may also include a D-ring 22. The loop 20 at the lower and 18 of the back strap 12 or D-ring 22 are preferably used, for attachment of the suspension relief extension 50 (shown in FIGS. 2 and 3). Alternatively, the suspension relief extension 50 may be permanently attached to the harness 10.

The back strap 12 and shoulder straps 14 preferably have one or more loops 24. As depicted in FIG. 1B, the present exemplary embodiment of harness 10 is provided with torso straps 26 inserted through loops 24 of back strap 12 and shoulder straps 14. Generally, the ends of the torso straps 26 preferably have buckles (for example, clip and clasp buckles or seat belt type buckles) or clips for securing the ends of the straps together, although any configuration that allows the harness 10 to be tighten around the user's body is acceptable. The torso straps 26 are preferably free to slide through the loops 24 in the shoulder and/or back straps (i.e., they are not affixed in place within either the harness or the garment) and ensures a more comfortable fit for the user.

As depicted in the exemplary embodiment disclosed in FIG. 1C, the harness may also incorporate the use of leg straps 40. The leg straps 40 depicted in FIG. 1C are an exemplary embodiment of the leg straps 40, but the leg straps 40 and their connection to the harness 10 may be configured in numerous ways. In the depicted configuration, the leg straps are removably attached to the harness, part of which is connected to the D-ring 22 at the lower end 18 of back strap 12, and part of which is connected to the shoulder straps. The leg straps may also be permanently affixed to and be part of the harness 10.

FIG. 2 depicts an exemplary embodiment of a harness showing one embodiment of the suspension relief extension 50. In this embodiment, the suspension relief extension 50 has a top end 52 configured to form a first loop 54. Preferably attached to the first loop 54 of the suspension relief extension is a connection device 56, for example a carabiner, for attachment of the suspension relief extension 50 to the harness 10, preferably to the D-ring 22 at the lower end 18 of back strap 12. The bottom end 53 of the suspension relief extension 50 is preferably configured to form a loop in which to place one or more of the user's feet so that the user can “stand” in the loop and relief the pressure on the leg straps 40. In this embodiment, when the user “stands” in the loop, virtually all of the weight of the user is transferred to and borne by the back strap 16 and into the tether to the fixed object, thus providing suspension relief.

In this preferred embodiment, the suspension relief extension 50 has an adjustment mechanism 55 to allow the length of the suspension relief extension 50 to be altered. In the preferred embodiment, a three bar slide is provided on the strap of the suspension relief extension 50 that allows for easy adjustment but enough friction so that the strap remains fixed during use.

The suspension relief extension 50 can be configured in any number of ways to connect to the harness 10. Just as alternative embodiments, one half of a buckle or connection device (for example one half of a clip and clasp buckle or seat belt style buckle), could be attached to the harness 10, and the other half attached to the suspension relief extension. Alternatively, the suspension relief extension 50 could be permanently affixed to the harness 10. The suspension relief extension 50 could also be connected to the torso straps 26.

Depicted in FIG. 3 is another embodiment of the suspension relief extension 50. In this embodiment, the suspension relief extension 50 is configured to have two loops at the bottom end 53 for both of the user's feet. The suspension relief extension 50 could also have multiple loops at varying distances along its length. Finally, the tether could optionally have one or more loops or handles (not depicted) to allow the user to grasp and pull themselves upward, either to provide additional suspension relief or to assist them in getting back onto the treestand.

Although several preferred embodiments of the present invention have been described using specific terms and devices, such descriptions are for illustrative purposes only. The words used are words of description rather than of limitation. It is to be understood that changes and variations may be made by those of ordinary skill in the art without departing from the spirit or the scope of the present invention, which is set forth in the following claims. In addition, it should be understood that aspects of various other embodiments may be interchanged both in whole or in part. Therefore, the spirit and scope of the appended claims should not be limited to the description of the preferred versions contained herein.

1. A safety harness suspension relieving system comprising:
a) a harness having at least one vertical back strap having a top end and a bottom end; and
b) a suspension relief extension operatively attached to said vertical back strap;
c) a tether operatively attached to said top end of said vertical back strap, wherein said tether is configured to connect to a fixed object.

2. The suspension relieving system of claim 1, wherein said suspension relief extension forms at least one loop to receive a user's foot.

3. The suspension relieving system of claim 2, wherein the suspension relief extension has two loops to receive the user's feet.

4. The suspension relieving system as in claim 1, wherein the length of said suspension relief extension is adjustable.

5. The suspension relieving system as in claim 2, wherein said suspension relief attachment is removably attached to said harness.

6. The suspension relieving system of claim 1, wherein the harness further comprises shoulder straps, and one or more torso straps.

7. The suspension relieving system of claim 6, wherein the harness further comprises leg straps.

8. The suspension relieving system of claim 1 wherein the length of said suspension relief extension is adjustable, said suspension relief extension forms at least one loop to receive a user's foot, and wherein the harness further comprises shoulder straps, one or more torso straps, and leg straps.

9. The suspension relieving system of claim 1, wherein the length of the suspension relief extension is adjustable using a three bar slide.

10. A method of providing suspension relief to a user of a safety harness, comprising:
a) connecting one end of a tether to a fixed object and the other end of the tether to a safety harness having a back strap and one or more shoulder straps;
b) connecting a suspension relief extension to the back strap of said safety harness; and
c) applying a force to the suspension relief extension.

11. The method of claim 10 wherein the safety harness further comprising torso straps and leg straps.

12. The method of claim 10 wherein the length of the suspension relief extension is adjustable.

13. The method of claim 10 wherein the suspension relief extension is configured such that the force is applied by a user's foot.

14. A safety system comprising:
a) a harness having a back strap;
b) a suspension relief attachment operatively attached to said back strap of said harness; and
c) a tether operatively attached to said back strap of said harness.

15. The safety system of claim 14, wherein said wherein force applied to the suspension relief extension transfers corresponding force directly to the tether.

16. The safety system of claim 14, wherein said harness further comprises shoulder straps, one or more torso straps, and leg straps.

17. The safety system of claim 14, wherein said suspension relief attachment is configured to have one or more loops to receive a user's foot.

18. The safety system of claim 14, wherein the length of said suspension relief attachment is adjustable.

19. The safety system of claim 14, wherein said suspension relief attachment is removably attached to said back strap.

20. The safety system of claim 18, wherein the length is adjustable using a three bar slide.
